(19) United States
(12) Patent Application Publication
(10) Pub. No.: US 2025/0367076 A1
(43) Pub. Date: Dec. 4, 2025

(54) CONTAINER, DEVICE, AND SYSTEM FOR TEMPERATURE-SENSITIVE MEDICATIONS, AND METHOD RELATED THERETO

(71) Applicants: Jay Dunigan, York, ME (US); Kevin Durand, Watertown, MA (US)

(72) Inventors: James F. Dunigan, III, York, ME (US); Kevin Durand, Watertown, MA (US)

(73) Assignee: VIABILITY, LLC, York, ME (US)

(21) Appl. No.: 19/048,949

(22) Filed: Feb. 9, 2025

Related U.S. Application Data
(60) Provisional application No. 63/551,835, filed on Feb. 9, 2024.

(51) Int. Cl. A61J 1/18; B65D 81/38

(52) U.S. Cl. CPC A61J 1/18; B65D 81/3841; A61J 2200/44; A61J 2200/50; A61J 2200/72; A61J 2205/60; B65D 2203/10

(57) ABSTRACT

A container for tracking the temperature of a temperature-sensitive medication includes an inner chamber configured to receive a dosage of medication, a thermal material encasing the inner chamber, an outer housing configured to retain the inner chamber and the thermal material, and a sensor within the inner chamber configured to communicate to a PCA board, powered by a battery. The container can also include a vacuum insulation jacket between the thermal material and the outer housing so as to further insulate the inner chamber.

### FIELD OF THE DISCLOSURE

The present disclosure relates to systems, methods, and devices for storing and protecting temperature-sensitive medications and other temperature-sensitive items.

### BACKGROUND OF THE DISCLOSURE

It is a well-known problem that insulin and other diabetes-related medications (for example, Ozempic®, Epinephrine®, Tysabri®), must be stored within a very specific temperature range (for example, 36-86 degrees Fahrenheit) or the medication (or medicine) can become unusable, or even toxic in some cases. If too cold, the medication could freeze, rendering it unusable in the frozen state, and ineffective due to molecular changes once thawed, and if too warm, it can likewise become ineffective, or even harmful. This is similarly true for other temperature-sensitive medications, such as inhalers, such as Albuterol Sulfate or Budesonide and Formoterol Fumarate Dihydrate Inhalation Aerosols. There are many systems and/or processes that have attempted to address this problem for temperature-sensitive medications and/or items. For example, there are systems that are essentially miniature refrigerators that can keep temperature-sensitive medications at a set temperature for a specific period of time, however this still requires a massive amount of power in order to operate. For example, the mini fridge generally requires a stationary unit or large batteries that are not practical for a small amount of medication or for transportation and/or portability.

### SUMMARY OF THE DISCLOSURE

It has been recognized that a container for tracking the temperature of a medication that may be temperature-sensitive includes an inner chamber configured to receive a dosage of the medication, a thermal material encasing the inner chamber, an outer housing configured to retain the inner chamber and the thermal material, and a sensor within the inner chamber configured to communicate to a PCA board, powered by a battery. The container can also include a vacuum insulation jacket between the thermal material and the outer housing so as to further insulate the inner chamber.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 is an overview block diagram of a system incorporating a container for storing a temperature-sensitive medication and monitoring a temperature of the temperature-sensitive medication, according to the present disclosure.

FIG. 2 is a diagram of a graph illustrating temperature as a function of time for an internal environment of a container and an external environment of the container, according to the present disclosure.

FIG. 3 is a cross-sectional view of the container for storing a temperature-sensitive medication, including a vacuum layer and an insulating material layer, according to the present disclosure.

FIG. 4 is a cross-sectional view of the container for storing a temperature-sensitive medication, including a single insulating material, according to the present disclosure.

FIG. 5 is a flow chart of a method for utilizing the container in conjunction with an application on a mobile device, according to the present disclosure.

FIG. 6 is a flow chart of a method for manufacturing the container, according to the present disclosure.

FIG. 7 is a diagram of a second graph illustrating temperature as a function of time for an internal environment of a container and an external environment, according to the present disclosure.

FIG. 8 is a schematic block diagram illustrating the components of a container for the medication, according to the present disclosure.

FIG. 9 is a schematic block diagram illustrating the components of a puck-style device for tracking the temperature of a medication, according to the present disclosure.

FIG. 10 is a diagram of a screen shot of a mobile application display for a mobile device of a user, in accordance with the present disclosure.

### DETAILED DESCRIPTION OF THE DISCLOSURE

In accordance with the present disclosure, a container for tracking and monitoring a temperature-sensitive medication is disclosed. The container has an internal chamber for receiving a dosage of the medication, an insulation layer, and an outer housing configured to retain the inner chamber and the insulation layer. The insulation layer can include a first insulating material sub-layer and a second vacuum insulation jacket between the thermal material and the outer housing. The inner chamber can include a sensor configured to communicate a temperature reading to a PCA board, powered by an internal battery. By tapping into the natural latency of temperature change within an insulated container (as compared to the outside temperature changes), the tracking and monitoring can be as efficient as possible, while alerting a user to potential exposure outside of the viable temperature range.

Advantageously, the container takes the “guesswork” out of ensuring that the temperature-sensitive medications are adequately stored. A user will know when the medicine has reached an unusable (or unsafe) temperature and/or how much time until the medicine will reach the unusable temperature (for example, it can tell you that you have four hours left until your medicine will become outside of the acceptable temperature range). The container and/or mobile application can appropriately tie into a weather API to track the external, environmental temperature proximate the container. The container ensures accurate temperature inside for an entire time, and notifies in the temperature goes outside of the range, or can send a notification when it is about to. The temperature range monitoring notification if below or above (outside of) a range is one benefit to the disclosed container. The goal is to maintain the temperature of the medication within the safe zone, and to alert the user if or when the temperature falls outside of the safe zone. Extending the temperature-controlled supply chain tracking already in use by medication manufacturer's to ensuring medication viability to the user.

By providing the layers of thermal insulation and thermal capacitance in combination, the effects of the environmental temperature change on the medication can be even further delayed. In some cases, the delay is adequate for environmental conditions to change such as day and night in a vehicle, and the medication is maintained at the desired temperature range for many days. Additionally, the temperature sensors can be equipped with pre-set or user set temperature notification points through an application or other similar means, allowing the user to take necessary action to prevent medication damage or spoil.

Note that the term “medication” and “medicine” may be used interchangeably herein, and both generally refer to a dosage or other serving of medicine, whether single dose or multiple doses, including but not limited to diabetes-related medication, inhalers, and other medications, as will be appreciated in light of the present disclosure.

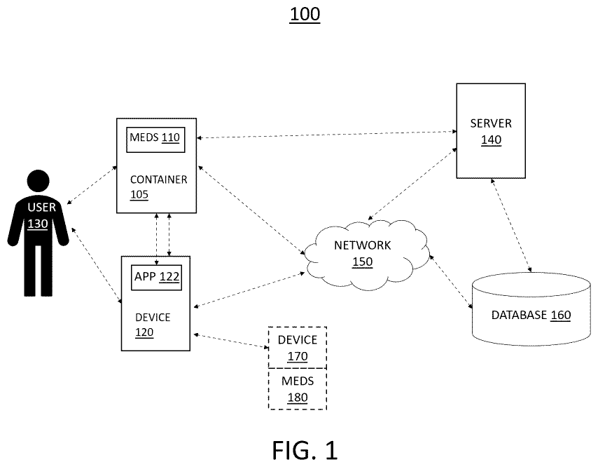

Referring to FIG. 1, an overview block diagram is shown of a system 100 incorporating a container 105 for storing a temperature-sensitive medication and monitoring a temperature of the temperature-sensitive medication, according to the present disclosure. The system 100 includes a container 105 having a medication 110 stored therein, which may be held or otherwise transported by a user 130. The user also has a mobile device 120 with an application 122 that may communicate with the container 105. The container 105 may be considered a “smart” container with the ability to communicate wirelessly to the device 120, or directly to a server 140, either via the network 130 or through other wireless transmission, such as NFC, Bluetooth, Bluetooth Low Energy (BLE), Radio Frequency Identifier (RFID), or other appropriate mechanisms. The container may also send out the temperature sensor signal at predetermined intervals, to be received by the device 120 if within a predetermined range of the container 105. The temperature sensor signal can also, or alternatively, be sent at predetermined intervals that are set by the user. This further improves the privacy and accuracy of the device by only allowing the temperature to be transmitted to the device 120 when desired. In some instances, the temperature may be stored locally on the container 105 and then transmitted to the device 120 and/or the server 140 as desired. The server 140 can collect user data as well as temperature data to track and monitor the temperature of the medication 110 within the container 105. This may be stored in a database 160 by the server 140 or directly by the mobile device 120.

The container can be a smart container, which can be powered by a battery, a solar powered system, or directly by alternating current in some situations, with an appropriate AC-DC converter to provide power and/or for charging. It will be appreciated that the mobile device and associated application are not necessary; the container could operate by sending info directly to a server once network connection is made and/or could communicate only to mobile device without the need for a separate server and/or database, as will be appreciated in light of the present disclosure.

It will be appreciated that the communication between the container 105 and the mobile device 120 can occur directly from the container to the application, or in some instances the container can send a text message or automated call to the device 120 directly (without the need for an intermediary device).

In some embodiments, a puck-style device 170 may be included in addition to, or instead of, the container 105 with integrated sensor configuration. The puck-style device 170 can be secured to the medication 180 by adhesive or magnet, or may be simply placed net to the medication 180 within a separate container (not shown) provided by the user 130 or by another third party. The device 170 allows for tracking of the medication through a sensor coupled in close proximity (or within a same container as) the medication 180.

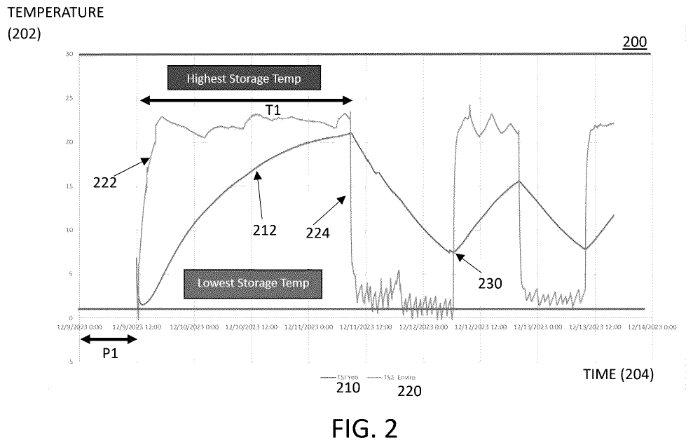

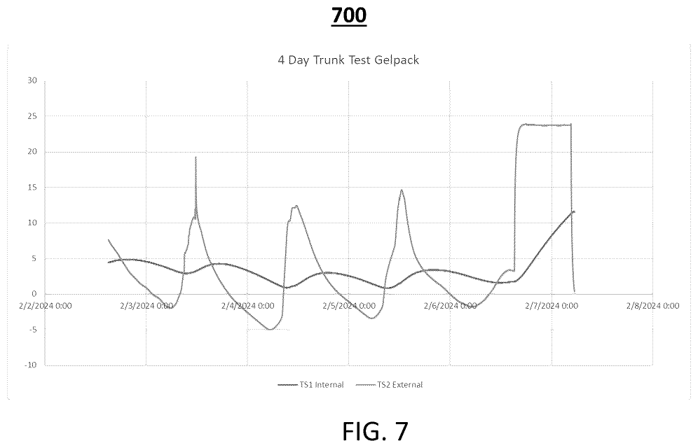

FIG. 2 is a diagram of a graph 200 illustrating temperature as a function of time for an internal environment of a container and an external environment of the container, according to the present disclosure. The graph illustrates temperature (202) as a function of time (204) where the period P1 of time is 12 hours. The graph illustrates the internal temperature 210 as measured within a container according to the present disclosure, as well as the external, environmental temperature 220. As can be observed on the graph, the internal temperature 210 has a very large latency (212) in transitioning from the colder temperature to the warmer temperature over time T1. In contrast, note the rapid incline (222) of the external temperature (222) as well as the rapid decline in external temperature (224). It will be appreciated that there is a “sweet spot” 230 where the internal temperature is proximate the bottom of the graph, and the external temperature (220) is proximate the top of the graph. This is caused by the response time between the change inside and the change outside. By tapping into this characteristic, and appropriately monitoring the temperature at pre-set intervals, this allows for the temperature to be checked less frequently (by increasing the amount of time in between measurements), conserving battery life, and even being able to project if the medicine will go outside of the acceptable temperature range, and alerting the user accordingly. This allows a user, for example, to determine that they have a certain amount of time (perhaps 4 hours) until their medication becomes unusable. Refer to FIG. 7 for a graph showing the temperature as a function of time for a second overall environment, according to the container of the present disclosure.

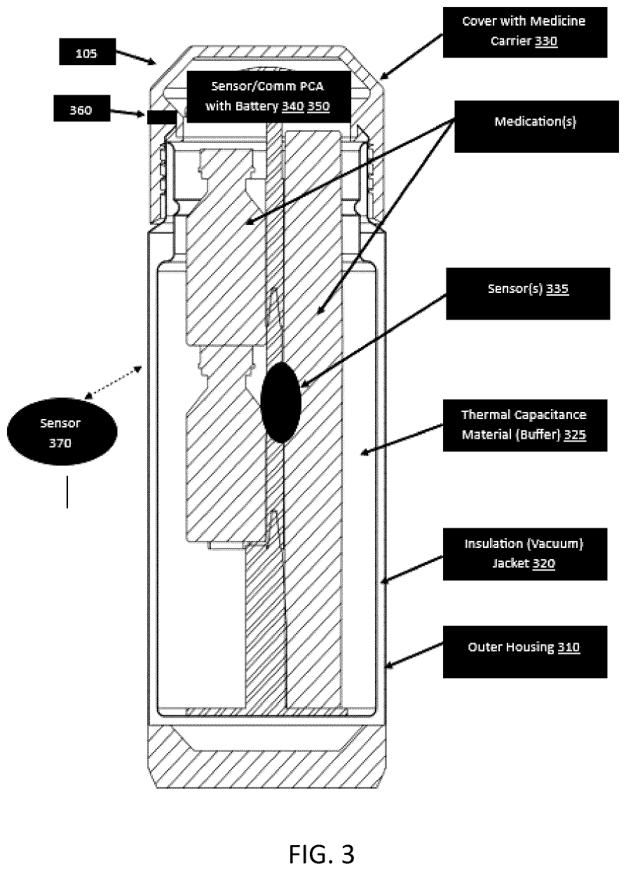

FIG. 3 is a cross-sectional view of the container 105 for storing a temperature-sensitive medication, including a vacuum layer and an insulating material layer, according to the present disclosure. The container includes an outer housing 310, an insulation (vacuum) jacket 320, a thermal buffer layer 325, and an inner chamber 330 for storing a medication (not shown). The inner chamber 330 may include a shelf or lip 332 for accommodating medications of varying sizes, such as a vial instead of a “pen” style insulin. The container 105 includes a sensor 335 for detecting an internal temperature within the container 105. The sensor may be positioned at any position within the internal chamber, including proximate the shelf 332 at 335a to detect the temperature of the medication. The container 105 includes a PCA (printed circuit assembly) board 340 that communicates with the sensor 335 and externally to the application 122 on the mobile device 120. The PCA 340 can include embedded firmware in the form of MEMS (micro-electro-mechanical-systems) thermometers with wireless connections to the sensor, which is tethered inside the chamber, and all driven by the internal battery 530. The container components are powered by an internal battery 350, which for example can be a lithium battery. The battery 350 can be rechargeable via a battery charge port 360 that can have a snap-fit or press-fit to preserve the insulating properties of the container 105.

The thermal buffer layer 325 is positioned proximate, or next to, the inner chamber 330 and is a material with a high efficiency storage of thermal energy, such as aluminum, surrounded by a vacuum jacket 320. It will be appreciated that this design minimizes the “dead space” within the container to maximize insulation properties overall.

The container may include or otherwise be coupled to a sensor 370 to detect an external, environmental temperature proximate the container 105. In some applications, the sensor 370 may be omitted, and the external temperature can be acquired by other means, such as a weather application or other weather information available on the mobile application or the server, or both. Although a separate sensor 370 is shown, it will be appreciated that this is not necessary, and for example, the temperature can be acquired by utilizing the Weather App on a phone, or otherwise connecting to local weather agencies to determine an approximate local temperature, by gathering information about the external environment generally. In some embodiments, a separate sensor may be provided to be placed proximate the container, or may be placed on an external surface of the container to detect external, environmental temperatures.

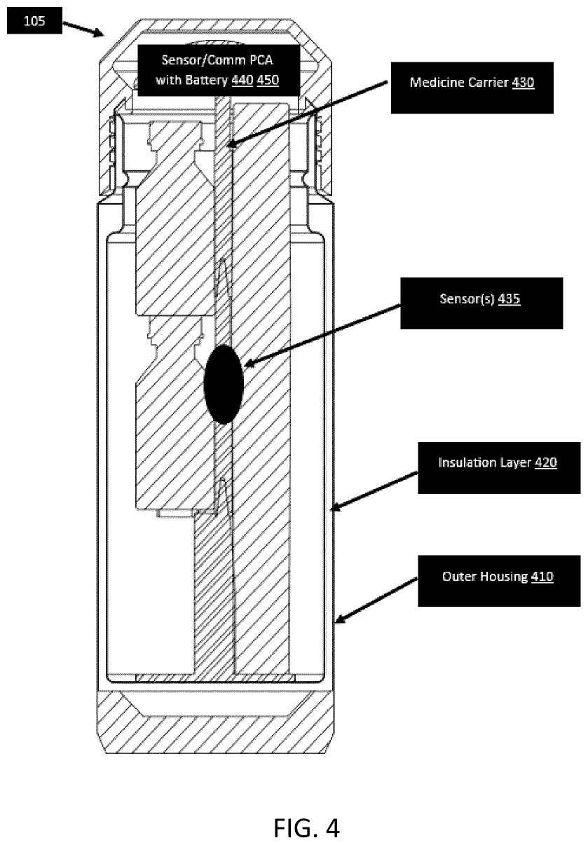

FIG. 4 is a cross-sectional view of the container 105′ for storing a temperature-sensitive medication, including a single insulating material, according to the present disclosure. The container 105′ is similar in structure and arrangement to the sensor 105 of FIG. 3, except that a single insulation layer is implemented, according to the present disclosure. It will be appreciated that either a single insulation layer (420), which can be either vacuum (air) or an actual insulating material, can be used in accordance with the techniques of the present disclosure, or the single insulation layer can be comprised of two sublayers, including vacuum and insulating buffer material layer, as will be appreciated in light of the present disclosure. The insulating material layer can comprise vacuum air, fiberglass, nitrogen gas, G10 (garolite, a high-pressure fiberglass laminate), phenolic, or other thermal insulating materials or gases.

The container 105′ includes an outer housing 410, an insulation layer 420, and an inner chamber 430 for storing a medication (not shown). The container 105′ includes a sensor 435 for detecting an internal temperature within the container 105. The sensor may be positioned at any position within the internal chamber to detect the temperature of the medication. The container 105′ includes a PCA (printed circuit assembly) board 440 that communicates with the sensor 435 and externally to the application 122 on the mobile device 120. The container components are powered by an internal battery 450.

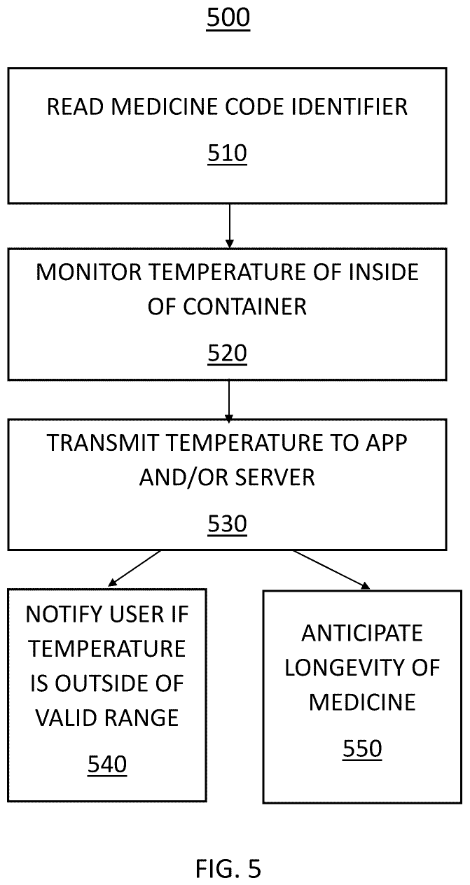

FIG. 5 is a flow chart of a method for utilizing the container in conjunction with an application on a mobile device, according to the present disclosure. The method 500 starts by reading the medicine code identifier at 510. The code identifier can provide the individual temperature history and assure that the drug temperature is maintained at the manufacturer's recommended temperature. At 520, the temperature inside of the container is monitored. This can be accomplished via the sensors 335, 435 as shown and described herein, for example. The container is capable of tracking and storing the temperature until the user requests the data. At 530, the temperature is transmitted to the application on the mobile device, or directly to the server. Then, the method can either notify the user if the temperature falls outside of the valid range 540, or anticipate the longevity of the medication 550, or both, depending upon the particular settings and/or preferences for a user. This information can be stored in computer readable media within or external to the container 105.

It will be appreciated that although only a single sensor is shown for purposes of illustration, any number and variety of sensors can be included in addition to a temperature sensor to achieve various functionality associated with a mobile electronic device, including but not limited to accelerometers to detect motion and/or position of the device or container; GPS to detect global positioning of the device or container; RH (relative humidity) sensor to detect humidity internally or externally to a container; and atmospheric pressure to detect pressure internally or externally to a container.

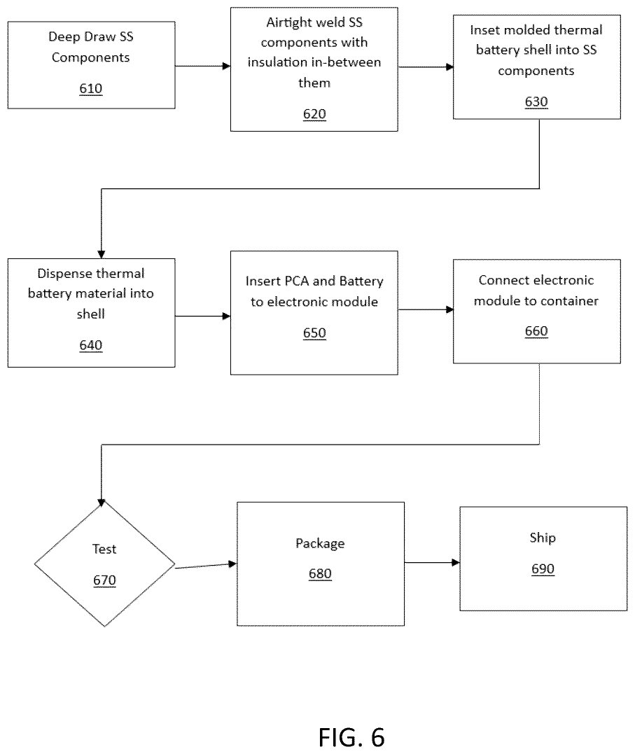

FIG. 6 is a flow chart of a method for manufacturing the container, according to the present disclosure. It will be appreciated that this is one example process for manufacturing the container, and that the steps may be performed in this order or in another order where appropriate, and that there may be additional or fewer steps than those disclosed, and there may be other methods of arriving at the container shown and described herein within the level of ordinary skill that are not explicitly disclosed but will be appreciated in light of the present disclosure.

At 610, a deep draw is performed of stainless steel (SS) components. It will be appreciated that stainless steel is one possible material, and others can be implemented to achieve the properties of the present disclosure. At 620, an airtight weld of the SS components is performed, with the insulation materials in between them. At 630, the molded battery shell is inserted into the SS components. At 640, the thermal battery material is inserted into the shell. This can be done by pouring or filling a battery gel. Additionally, this component could be pre-formed/molded to be inserted into the assembly. The PCA and battery is then inserted into the electronic module at 650. The electronic module is then connected to the container at 660. And then the product is tested at 670, packaged at 680, and then shipped for use at 690.

FIG. 7 is a diagram of a second graph 700 illustrating temperature as a function of time for an internal environment of a container and an external environment, according to the present disclosure. It will be appreciated that the same general properties are visible in both FIG. 2 and FIG. 7, which illustrate different data points captured for the container in accordance with the present disclosure.

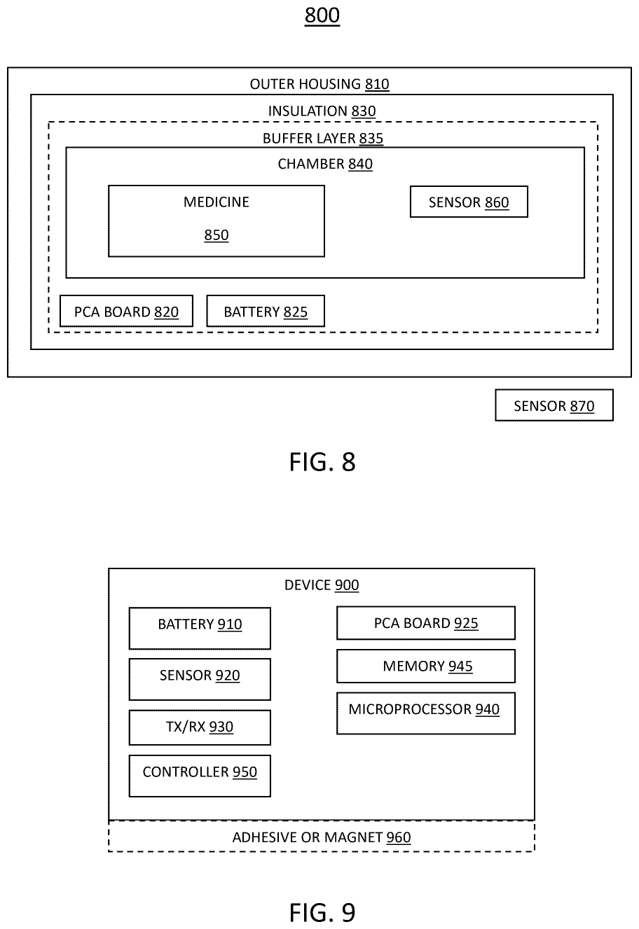

FIG. 8 is a schematic block diagram illustrating the components of a container for the medication, according to the present disclosure. FIG. 8 illustrates the components of a container 800 in a schematic block diagram illustration, and this can be the same as, or similar to, the container 105 as shown in FIG. 1 and FIG. 3, or the container 105′ shown in FIG. 4. As illustrated, the container 800 includes an outer housing 810, an insulation layer 830, and an optional buffer layer 835. This defines a chamber 840 in which medication 850 is stored. A sensor 860 is provided in the container and is coupled to the PCA board 820 and a battery 825. An external sensor 870 may also be disclosed.

FIG. 9 is a schematic block diagram illustrating the components of a puck-style device for tracking the temperature of a medication, according to the present disclosure. The device 900 may be a puck-style device, similar to device XX shown in FIG. 1. The device 900 includes a battery 910, a sensor 920, a transmitter/receiver 930, controller 950, PCA board 925, memory 945, and microprocessor 940. In some cases, the controller may be omitted and only a microprocessor is used in combination with memory, or vice versa a microprocessor may be omitted and only the controller is used in combination with memory, as will be appreciated in light of the present disclosure. The device 900 can include an adhesive or a magent 960 for securing the device 900 to a medication. The device 900 may be placed within a container provided by the user or by a third party to achieve the temperature tracking and notification features according to the present disclosure.

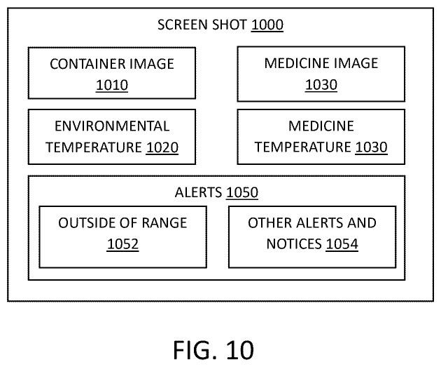

FIG. 10 is a diagram of a screen shot of a mobile application display for a mobile device of a user, in accordance with the present disclosure. The screen shot 1000 can be displayed via the application 122 on the mobile device 120. The screen shot 1000 includes a container image 1010, the environmental (exterior/outside) temperature 1020, a medicine image 1030, a medicine temperature 1030, and alerts 1050, which may include alerts regarding the temperature being outside of the range 1052 and other alerts and notices 1054.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A container for tracking the temperature of a medication, the container comprising:
an inner chamber configured to receive a dosage of the medication;
a thermal material encasing the inner chamber;
an outer housing configured to retain the inner chamber and the thermal material; and
a sensor within the inner chamber configured to communicate to a PCA board, powered by a battery.

2. The container of claim 1, further comprising a vacuum insulation jacket between the thermal material and the outer housing so as to further insulate the inner chamber.

3. The container of claim 1, wherein the container is configured to read a code identifier of the medication.

4. The container of claim 1, wherein the medication comprises a temperature-sensitive medication that comes in a vial or a pen.

5. The container of claim 4, wherein the inner chamber includes a shelf for supporting the vial.

6. The container of claim 4, wherein the PCA board is configured to receive external, environmental weather data from an external weather sensor.

7. The container of claim 1, wherein the PCA board is configured to communicate with a mobile device on a mobile application to project how long the medication is valid.

8. The container of claim 7, wherein the mobile application is configured to notify the user when the medication goes above a predetermined high temperature or falls below a predetermined low temperature.

9. The container of claim 1, wherein the PCA board is configured to determine a sample time for sensing the temperature within the inner chamber.

10. The container of claim 1, wherein the container has a height in the range of at least 2-inches up to 10-inches, a width in the range of 2-inches up to 4-inches, and a depth in the range of 0.25-inches to 2-inches.

11. A device for tracking a medication, the device comprising:
a sensor for determining a temperature proximate the medication;
a transmitter for transmitting the temperature of the medication; and
a battery for the sensor and the transmitter.

12. The device of claim 11, wherein the device includes memory with a predetermined temperature specific to the medication, and wherein the memory includes instructions to transmit an alert when the temperature of the medication exceeds the predetermined temperature.

13. The device of claim 12, wherein the device is configured to send an alert directly to a mobile device of a user, directly to a mobile application running on the mobile device of the user, or directly to an email address associated with the user.

14. The device of claim 11, wherein the device is configured to be affixed to the medicine by an adhesive or a magnet.

15. The device of claim 11, wherein the device is configured to be placed within an insulated container proximate the medication.

16. A method of verifying a medicine, the method comprising:
monitoring a temperature of the medicine with a device having at least one temperature sensor;
transmitting the temperature;
determining if the temperature is within a valid range;
when the temperature is not within a valid range, notifying the user.

17. The method of claim 16, further comprising anticipating a longevity of the medicine.

18. The method of claim 16, further comprising reading a code identifier on the medicine to determine the valid range of temperature for the medicine.

19. The method of claim 16, wherein notifying the user comprises a direct message from the device to a mobile device of the user.

20. The method of claim 16, wherein notifying the user comprises a message to a mobile application running on a mobile device of the user.
